(19) United States
(12) Patent Application Publication
(10) Pub. No.: US 2009/0009593 A1
(43) Pub. Date: Jan. 8, 2009

(54) THREE DIMENSIONAL PROJECTION DISPLAY

(75) Inventors: Colin David Cameron, Worcestershire (GB); Christopher Paul Wilson, Shropshire (GB); Anton De Braal, Worcestershire (GB)

Correspondence Address: Stolowitz Ford Cowger LLP, 621 SW Morrison St, Suite 600, Portland, OR, 97205, US

(73) Assignee: F.POSZAT HU, LLC, Willmington (DE)

(21) Appl. No.: 11/947,717

(22) Filed: Nov. 29, 2007

Related U.S. Application Data
(60) Provisional application No. 60/861,430, filed on Nov. 29, 2006.

(51) Int. Cl. H04N 13/04

(52) U.S. Cl. 348/51; 348/E13.001

(57) ABSTRACT

A display system includes a screen and a plurality of projectors configured to illuminate the screen with light. The light forms a three dimensional (3D) object for display in a viewing region. The system further includes one or more processors configured to generate image information associated with the 3D object. The image information is calibrated to compensate for a projector bias of the plurality of projectors by transforming a projector perspective of the 3D object to a viewing region perspective.

This application claims priority to U.S. Provisional Application Ser. No. 60/861,430 filed on Nov. 29, 2006, the specification of which is herein incorporated by reference.

### FIELD OF USE

Three dimensional display systems, including projection display systems and autostereoscopic three dimensional displays.

### BACKGROUND

Display systems incorporating a plurality of projectors are used in both two dimensional (2D) and three dimensional (3D) display systems. Those used to create 3D displays take various forms. One form uses a plurality of projectors to create a tiled image of high resolution onto a projection screen, and puts an array of lenses in front of the screen, with each lens being arranged to image a small part of the screen. The lenses in such a system are often arranged in a single axis lenticular array. The viewer then sees, due to the action of the lenses, a different set of pixels depending on his viewpoint, thus giving a 3D-like appearance to suitably projected image data. This method does not rely on a plurality of projectors, but will benefit from the additional pixel count provided by them.

A 3D image may also be formed by arranging a plurality of projectors in relation to a screen such that an observer looking at different parts of the screen will see components of images from different projectors, the components co-operating such that a 3D effect is achieved. This does not require an array of lenses, and can give a better 3D effect, as the resultant image can have an appreciable depth as well as merely looking different from different viewpoints. Better results are achieved with more projectors, as this provides for both a larger angle of view, and a more natural 3D image. Traditionally, the image rendering requirements of such a display become quite onerous for a system as the number of projectors increases, leading to an economic limitation on the quality obtainable. Also, as the number of projectors increases the setup of each of the projectors in relation to each other projector becomes more difficult

The rendering carried out by these systems is relatively simple in concept, but requires relatively significant processing resources, as data to be displayed on each projector is rendered using a virtual image generation camera located in a viewing volume from which the autostereoscopic image may be seen. The virtual image generation camera is a point from which the rendering takes place. In ray tracing terms it is the point from which all rays are assumed to emanate, and traditionally represents the point from which the image is viewed. For autostereo displays, rendering is traditionally carried out for several virtual image generation camera positions in the viewing volume, and is a computationally intensive task as stated in the paragraph above.

### BRIEF DESCRIPTION OF THE DRAWINGS

The various embodiments will now be described in more detail, by way of example only, with reference to the following diagrammatically illustrative Figures, of which:

FIG. 1 shows a representation of a projection system upon which a three dimensional projection display may be implemented;

FIG. 2 shows the frustra of a projector that may be provided in the projection system of FIG. 1, and an illustrative example of the rendering of image information;

FIGS. 3 and 4 show a point p in system-space being projected through a point p′ to appear in the correct spatial location for an observer;

FIG. 5 illustrates an embodiment of a three dimensional projection display including a curved screen; and

FIG. 6 illustrates a distortion effect that may occur with certain images produced by three dimensional projection systems.

### DETAILED DESCRIPTION

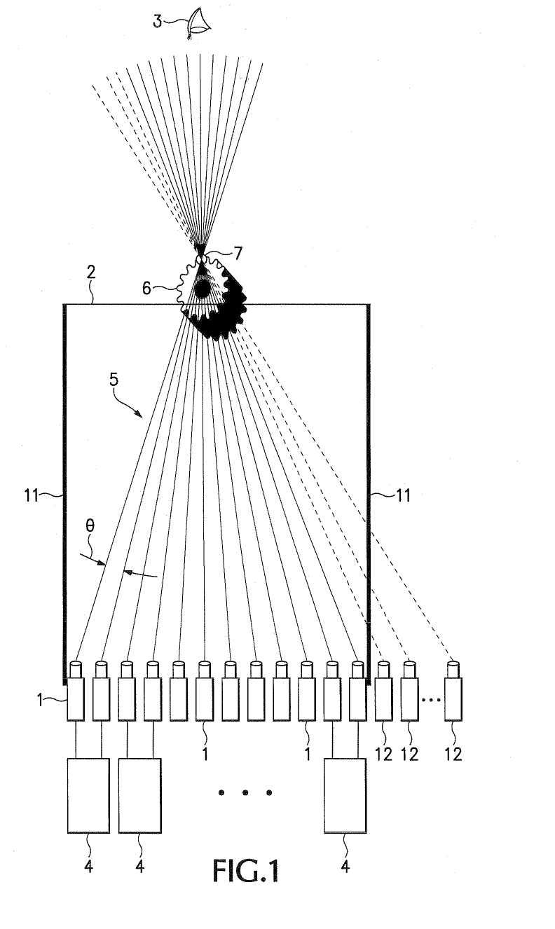

FIG. 1 shows a representation of a projection system upon which a three dimensional projection display may be implemented. The projection system is a Horizontal Parallax Only (HPO) system, although the principle of operation disclosed herein can be applied to other systems. A plurality of projectors 1 are each arranged to project an image onto a screen 2. The screen 2 has dispersion properties such that in the horizontal plane the dispersion angle is very small, at around 1.5°, whereas in the vertical plane the dispersion angle is rather wider at around 60°.

The projectors 1 may be arranged such that the angle θ between two adjacent projectors and the screen is no more than the horizontal dispersion angle of the screen 2. This arrangement ensures that a viewer 3 on the other side of the screen 2 will not see any gaps in the image which cannot be illuminated by at least one of the projectors 1.

The projectors 1 do not have to be lined up with respect to each other or with respect to the screen with any great precision. A calibration step (described below) can be carried out to compensate for projector positioning or optical irregularities, and for irregularities in the screen.

A computer cluster comprising a plurality of networked computers 4 may be used to carry out the graphical processing, or rendering, of images to be displayed. More specialized hardware could be used, which would reduce the number of separate computers needed. Each of the computers 4 may contain a processor, memory, and a consumer level graphics card having one or more output ports. Each port on the graphics card may be connected to a separate projector. One of the computers 4 may be configured as a master controller for the remaining computers.

FIG. 1 further shows a series of light rays 5 being projected from the projectors 1 towards the screen 2. A single ray is shown for each of the projectors 1, although in reality each projector will be emitting projections from a grid of pixels within its projection frustum. Each ray 5 shown is directed towards producing a single display point, e.g. 7, in the displayed image. This display point is not on the surface of screen 2, but appears to an observer to be some distance in front of it. Each projector 1 may be configured to send a ray of light corresponding to the image, or a part of the image, to a different part of the screen 2. This may lead to projector bias, where the image is displayed according to a projector perspective, or a distorted image appearing on the screen. In one embodiment, the vertices of the 3D object to be displayed are operated on or pre-distorted in a manner described below to correct for the projector bias.

A display of a 3D image according to one embodiment takes place in the following manner.

1. Application data comprising 3D image information is received in the master computer as a series of vertices. This may be for example information from a CAD package such as AUTOCAD, or may be scene information derived from a plurality of cameras. The master computer (or process) sends the data across the network to the rendering computers (or processes).

2. Each rendering process receives the vertices and carries out the rendering for each of its allotted projectors, compensating for certain visual effects due to projector bias or distortions added to the image by the system. The visual effects may be compensated for by operating on the image information prior to the light being rendered.

3. Once the 3D data has been properly projected into the 2D frame buffer of the graphics card, further calibration data is applied to correct for misalignments of the projectors, mirror and screen surface, by further manipulating or operating on the pre-distorted vertices.

A customized operation of the vertices making up the 3D image may be performed that takes into account the characteristics of the projection frusta. The rendering (or ‘camera’) frustum for each projector in the system may not be identical to the physical projector's frustum. Each projector 1 may be set up such that it addresses the full height of the back of the screen (i.e. it covers the top and bottom regions). Due to the HPO characteristics of the screen, the rendering frusta may be arranged such that each frustum's origin be coplanar with its associated projector in the ZX plane, and its orientation in the YZ plane be defined by the chosen viewer locations.

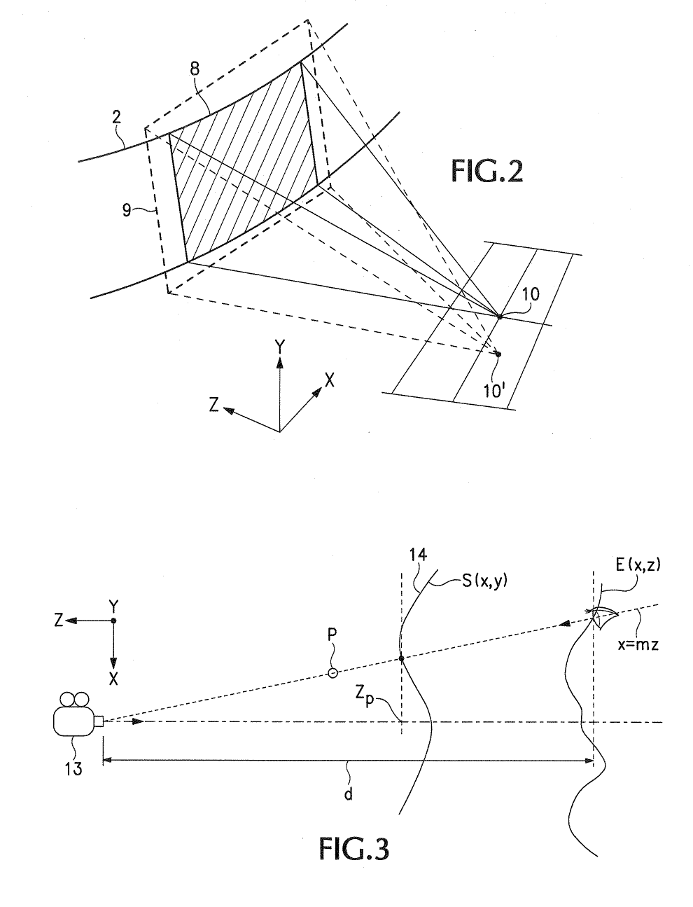

FIG. 2 shows the frusta of a projector that may be provided in the projection system of FIG. 1, and an illustrative example of the rendering of image information. Part of a screen 2, along with an ‘ideal’ rendering frustum 8 (hatched region), and the physical projector frustum 9 are shown. The projector frustum 9 is produced by a projector typically misaligned from an ‘ideal’ projector position 10. Note that the ideal projector position 10 is coplanar with the actual position 10′ in the ZX plane.

The extents of the rendering frusta may be chosen such that all possible rays are replicated by the corresponding physical projectors. In one embodiment, the rendering frusta in system-space intersect the physically addressed portions of the screen.

Certain misalignments of the physical projectors, such as rotations and vertical offsets, are corrected by calibration and image warping, as explained later.

Looking again at FIG. 1, it can be seen that by placing mirrors 11 along the sides of the bank of projectors 1 a plurality of virtual projectors 12 are formed by the reflected portion of the projectors' frusta. This gives the effect of increasing the number of projectors, and so increases the size of a view volume in which the image 6 may be observed by observer 3. By computing both the real and virtual projector frusta for a mirrored physical projector, the correct partial frusta are projected onto the screen. For instance, in an embodiment including an autostereo display each computer's (4) graphics card's frame-buffer may be loaded with the two rendered images side-by-side. The division between the rendered images may be aligned to the mirror boundary.

In order to correct for the HPO distortions mentioned above, and to present the viewer with a geometrically correct world-space from all viewpoints, the image geometry may be operated on or pre-distorted prior to rendering. In order to define the viewer's locus with respect to the screen for a completely accurate distortion correction, an arbitrary motion of the eye may be provided.

For a multi-viewer multi-viewpoint autostereo system, it may not be possible to track every viewer simultaneously. Therefore a compromise is accepted where the viewer loci are defined to be the most common. In one embodiment, a depth of view is chosen that lies at the centre of a viewing volume. However, this method allows for a real-time update of a viewer's position, for example through varying the co-ordinates in the following mathematical representation of the system.

When displaying imagery from an external 3D application, it is important to truthfully represent its eye-space (or application-space), and that includes preserving the central viewpoint and producing perspectively correct objects.

The mathematical representation of the system defines the user's viewpoint (from an external application) as being mapped to the central axis of the eye (i.e. along the Z-axis in eye-space). This allows the user's main viewpoint to resemble the application's, and gives users the ability to look around the objects displayed, by moving around in the view-volume.

In further defining the mathematical representation of the system, a 4×4 matrix M_{A} is identified, wherein the matrix M_{A} is understood as being able to transform the application's eye-space into the application's projector-space. Once in projector-space, let the projection matrix P_{A} represent the projection into the application's homogeneous clip space.

We now “un-project” into the display eye-space by applying an inverse eye projection matrix P_{E}⁻¹, and further map into the system-space using the inverse eye transformation matrix M_{E}⁻¹. Once in system-space, a general transformation matrix T can be applied, for example to allow the containment of an application in a sub-volume of the display. The rendering camera transformation matrix Mp may be used to map into projector-space for geometric pre-distortion.

Having operated on or pre-distorted the geometry in projector-space, we then perform a pseudoscopic projection H_{z}Pₚ into our camera's pseudoscopic homogeneous clip space. The pseudoseopic transformation may be represented as:

$${H}_{Z} = [ \begin{matrix}( - ) 1 & & & \\ & ( - ) 1 & & \\ & & ( - ) 1 & \\ & & & ( - ) 1\end{matrix} ] \qquad ( Eqn . 1 )$$

The signs in brackets may be understood to represent flipping or flopping of the image. In one embodiment, the image is flipped to compensate for the projection mode of the projectors.

A homogeneous point P=<Pₓ, P_{y}, P_{z}, 1> in application-space, before mapping into normalized device co-ordinates, may be represented as:

P′=Hz.Pₚ.D(x,y,z;E).Mₚ.T . . . M_{E}⁻¹.P_{E}⁻¹.P_{A}.M_{A}.P (Eqn 2)

Where D(x,y,z;E) represents the operation or pre-distortion as a function based on the co-ordinates of the point, and the position of the eye, in projector-space, as is described below.

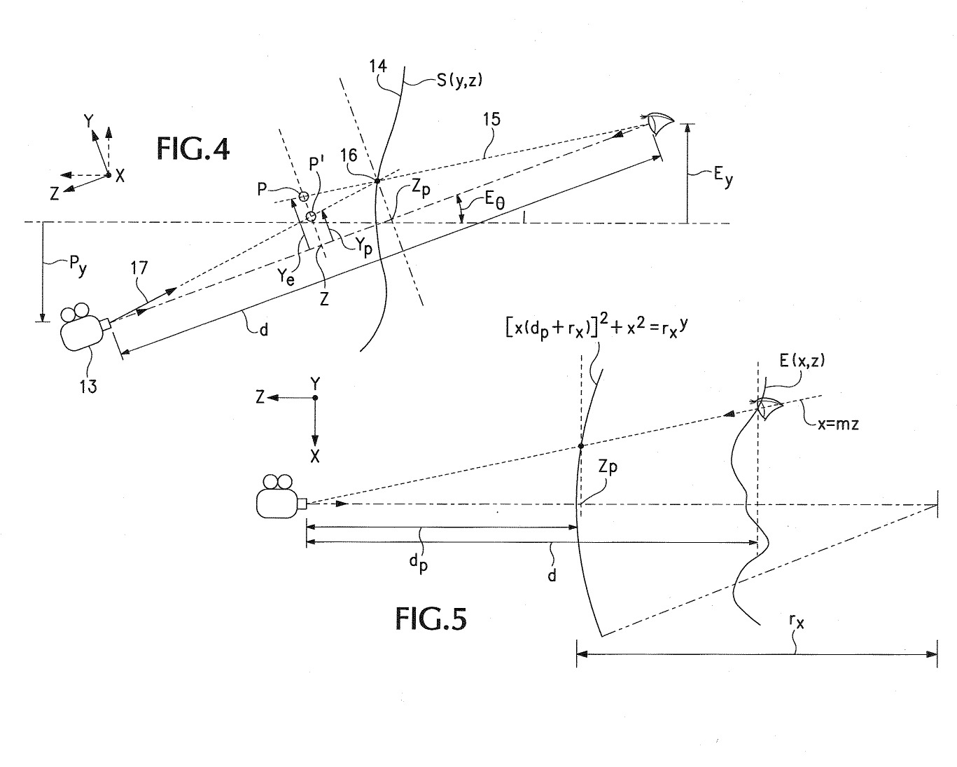

FIGS. 3 and 4 illustrate calculations that may be performed in operating on the image before it is displayed by a given projector. A projector 13 may be configured to project a ray of light to contribute to point p, sitting a short distance back from the screen 14. An observer looking at a point p of a 3D image sees a ray 15 that passes through the screen 14 at point 16.

A projector 13 that is projecting a ray of light 17 to make up point p may direct the ray 17 not directly at point p, but at the part of the screen 14 at which point p appears to the observer (i.e. through the point p′). Ray 17 may be operated on to provide an amount of pre-distortion for point p, to compensate for the difference between the projector viewpoint and the observer viewpoint. All points, or vertices, that make up the 3D image may be similarly operated on. Although, it should be understood that all the remaining points that are on the screen 14, other than those making up the 3D image, may not be altered or similarly operated on.

In order to pre-distort the point p in projector-space, it is possible to determine the distance d from the projector origin to the eye origin in the YZ plane, and locate the Z co-ordinate of the projector ray intersection with the screen zₚ.

The eye's view of the height of a point p in projector-space, yₑ, at a given depth z, is mapped to the target height yₚ that projects through the common point at the screen. Thus, due to the HPO nature of the screen, the projected point p′ appears at the correct position to the viewer.

With further reference to FIG. 4, it can be seen that for a given projector ray, based on the height E_{y} and X-axis rotation E_{Θ} of the eye, the effective height, P_{y}, and orientation of the projector origin may be calculated.

Thus the pre-distorted height of a point, yₚ, may be calculated:

$${y}_{p} = [ \frac{z}{{z}_{p}} \cdot \frac{d + {z}_{p}}{d + z} ] \cdot {y}_{e} \qquad ( Eqn . 3 )$$

FIG. 5 shows an embodiment of a three dimensional projection display including a curved screen. The projection co-ordinates may be operated on to correct for a distortion when the curved screen is used. In one embodiment, the value of zₚ may be found from the intersection of a particular ray (defined by the equation x=mz) and the screen.

The general transformation matrix T may, as stated above, be used to provide independent image information to different regions of the viewing volume. The independent image information may comprise for example one image that is visible from one half of the viewing region, and a second image that is viewable from the other half of the viewing region. Alternatively, the independent image information may be arranged such that a first image is projected to a viewer in a first location, and a second image is projected to a viewer in a second location. The viewer locations may be tracked by using head tracking means, and, by making suitable changes to the value of matrix T corresponding to the tracked locations, each viewer will maintain a view of their chosen image where possible as they move within the viewing region.

The projectors and screen of various embodiments disclosed herein may be positioned without concerns for extreme positional accuracy. A software calibration phase can be carried out such that deviations in projector position and orientation, such as can be seen in the difference between positions 10 and 10′ in FIG. 2, can be compensated for. Note again that the rendering frustum origin may be coplanar with the projector's frustum in the ZX plane. The calibration is done in one embodiment by means of the following:

1. Place over the screen a transparent sheet onto which has been printed a grid of reference lines;

2. For the first projector, arrange for the computer that controls the projector to display a pre-programmed grid pattern;

3. Adjust display parameters such as extent and curvature of projection frustum in x and y axes such that the displayed grid is closely aligned with printed grid;

4. Store the extent of the adjustments made in relation to projector in a calibration file; and

5. Repeat steps 2 to 4 for each of the projectors in the system.

The calibration files so produced contain calibration data that may be used both before and after the pre-distortion rendering phase to apply transformations to the pre-distorted image data to compensate for the positional and orientation errors previously identified.

A further calibration stage may be carried out to correct differing color and intensity representation between the projectors. Color and intensity non-uniformity across the projector images may be corrected at the expense of dynamic range, by applying RGB weightings to each pixel.

Other embodiments may utilize other facilities of modern graphics cards while still being able to produce real-time moving displays. For example, the geometric pre-distortion outlined above may be enhanced to include a full treatment for non-linear optics. Modern graphics cards can utilize a texture map in the vertex processing stage, which allows one to compute off-line corrections for very complicated and imperfect optics. Examples of such optics include curvilinear mirrors and radial lens distortions.

Various embodiments have utility in many different areas. These include, but are not limited to, volume data such as MRI/NMR, stereolithography, PET scans, CAT scans, etc., and 3D computer geometry from CAD/CAM, 3D games, animations, etc. Multiple 2D data sources may also be displayed by mapping them to planes at arbitrary depths in the 3D volume.

A further application of various embodiments includes replacing computer generated images with those from multiple video cameras, to allow true “Autostereo 3D Television” with live replay. By either using multiple cameras at different locations, or one camera moved to different locations in time to build up an image, multiple views of a scene may be collected. These separate views may be used to extract depth information. In order to reproduce this 3D video feed, the data may be re-projected pseudoscopically with the correct pre-distortion outlined above. Other methods of depth information gathering may be used to compliment the multiple video images, such as laser range-finding and other 3D camera techniques.

With the advent of relatively low cost programmable graphics hardware, the pre-distortion of images has been successfully implemented within the graphics processing unit's (GPU's) vertex processing stage in the graphics card of each computer. By pre-distorting each vertex, the subsequent interpolation of fragments approximates to the target amount of pre-distortion. A sufficient number of vertices—fairly evenly spaced—may be provided throughout the geometry, to ensure that the resultant image is rendered correctly. By offloading the pre-distortion of each vertex onto the GPU, real-time frame rates may be achieved with very large 3D datasets.

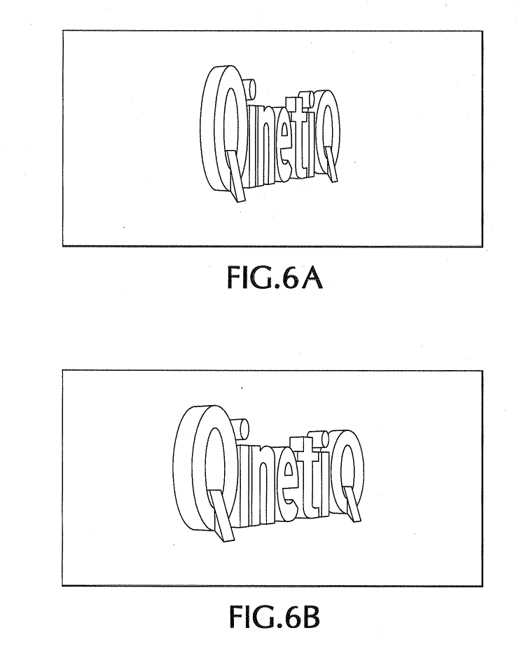

Some systems exhibit image artifacts that manifest themselves as a bending phenomenon, as shown in FIG. 6a. This can occur in images having elements that stretch from the front of the view volume to the back, or which occupy a significant part of the view volume either side of the screen This occurs primarily if a perspective projection is used in the image rendering.

Certain embodiment comprise a perspective projection with one or more vanishing points. By changing the projection to an orthographic projection, which does not have vanishing points (or may otherwise be regarded as effectively having all vanishing points at infinity), the bending phenomenon may be reduced. However, this can lead to an unnatural appearance of objects in itself.

The projection of different parts of the same object can be adapted according to the apparent distance of each part of the object from the screen. For example, those parts of the displayed object that are close to the screen may be displayed in perspective projection, while those parts at a maximum distance from the screen may be displayed using an orthographic projection, with intermediate parts being displayed using some combination of both perspective and orthographic projections. This change in projection can occur in a graduated manner as the apparent object distance increases, so leading to a more pleasing image. FIG. 6b shows an operated on image, with reduced bending.

The current project has been referred to as Projector Space Image Generation (PSIG), as various embodiments approach the rendering from the point of view of the projector, as opposed to the viewer oriented rendering. Image information is received in a form representative of a 3D object. The image information is operated on to compensate for a projector bias associated with one or more projectors. The projector bias is compensated for by transforming the projector perspective into a viewing region perspective. Light rays corresponding to the operated on image information are projected from each of the one or more projectors through a screen to a viewing region.

Effectively, the PSIG approach carries out the image rendering from the projector, co-locating a virtual image generation viewpoint, or virtual camera, which, in raytracing terms would be the eye of a viewer or camera, with the projector itself. Of course, this does not mean that actual viewpoint of the resultant image is co-located with the projector—the term “virtual image generation viewpoint” may refer to an effective viewpoint taken for the purposes of the image computation, or rendering. This is contrasted with the actual viewpoint of a viewer of the resultant image, as it is normally done in ray tracing applications. The actual positions of the virtual cameras may be exactly co-located with the projector positions, or may be positions relatively close to the actual projector positions, in which case a correction factor may be used to account for the positional difference. By reducing (virtually zero) the post rendering information transfer operation, the camera to projector mapping phase is simplified.

Accordingly, generation of an autostereoscopic image of high quality, but with a much reduced requirement for processing power, is herein described for rendering the images to be projected. The correct light rays to be projected from the projector side to the screen, and through to an imaginary observer, may be calculated to generate a geometrically accurate image to be displayed. It has been found that such a ray trace method allows the rendering of an image frame from a single projector to be carried out in a single pass. This is contrasted with a rendering from the viewer side of the screen, which can result in orders of magnitude increase in the number of mathematical operations required.

Various embodiments disclosed herein are described as being implemented on a Horizontal Parallax Only (HPO) autostereo projection system. Although various embodiments could be applied to a vertical parallax only system, or a full parallax system as required, by making the appropriate changes to the configuration of the projection system and rendering software.

The screen provided for various embodiments may be adapted for HPO use, by means of being asymmetric in terms of its angle of diffusion. Light hitting the screen from a projector is scattered widely, approximately 60°, in the vertical plane to provide a large viewing angle, but relatively very narrowly in the horizontal plane. Typically the horizontal scattering may be approximately 1.5°, 2° or 3° although the angle may be adapted to suit the given system design parameters. This diffusion property means that the system is able to control the propagation direction of the light emitted by the projectors very precisely, and in this way the system is able to provide different images to each of a viewer's eyes in a large volume to produce a 3D effect. The angle of dispersion of the screen may be chosen according to other parameters such as the number of projectors used, the optimal viewing distance chosen, and the spacing between projectors. A larger number of projectors, or projectors that are spaced closer together will typically use a screen with a smaller dispersion angle. This will lead to a better quality image, but at the cost of either more projectors or a smaller viewing volume. The screen may be transmissive or reflective. Whereas various embodiment are described herein in terms of using a transmissive screen, a reflective screen could also be used.

When using a screen material that has horizontal-parallax-only (HPO) properties, certain distortions may be noticeable. These distortions are common to all HPO systems, and involve an image that lacks the correct vertical perspective. Such effects include the foreshortening of an object, and the apparent tracking of objects with the vertical motion of the eye.

In a further embodiment, a screen comprises a material having a narrow angle of dispersion in at least one axis. An autostereoscopic image is displayed on the screen. One or more projectors may be arranged to illuminate the screen from a different angle.

Due to the decrease in processing power as compared to viewer space image generation systems, the display of complex real-time computer animations is possible whilst still utilizing relatively cheap off-the-shelf computer systems. The possible inclusion of live video feeds also opens up the use for a suitable camera system to produce a 3D autostereo television system.

The image information received by one or more projectors may include information relating to the shape of an object to be displayed, and may further include information relating to color, texture, brightness levels or any other feature capable of being displayed.

Image information may be received in a form representative of a 3D object. The image information is distributed to a processor or processors associated with the one or more projectors. In one embodiment, each projector is associated with a different processor, and each processor is configured to process or render a part of the image information. Each of the one or more projectors are arranged to project an image in a projection frustum to the screen. Differing parts of the projected image within each projector's frustum are rendered to represent a predetermined view of the overall image. The images from each of the one or more projectors are combined to produce an autostereo image in a view volume. In one embodiment, the rendering that is carried out for a given projector uses a virtual image generation camera co-located with the image projector.

Note that for the purposes of this specification the one or more projectors may comprise a traditional and commonly available projector system having a light source, a spatial light modulator (SLM) of some sort, and a lens. Alternatively, the one or more projector may comprise an individual optical aperture with a SLM shared with a neighboring optical aperture. The light source and SLM may be coincident.

Glossary of some of the terms used in this specification
Application-space. The eye-space of an external application to be mapped into our display.
Autostereo. Binocular disparity (and potentially motion parallax) without the need for special glasses.
Camera-space. See projector-space.
Eye-space. The co-ordinate system of a viewer in world-space.
Full Parallax (FP). Showing parallax in both the horizontal and vertical dimensions.
Frustum (pl. frusta). A projection volume; typically resembling a truncated square-based (four-sided) pyramid.
Homogeneous Clip Space (HCS). The co-ordinate system after the perspective projection into a cube.
Homogeneous Coordinates. Representation of vectors in four dimensions, where the fourth component becomes the w coordinate.
Horizontal Parallax Only (HPO). Only showing parallax in the horizontal plane.
Object-space. The local co-ordinate system in which 3D objects are defined.
Projector-space. The rendering or ‘camera’ co-ordinate system.
System Geometry. A property of the system including: Relative positions and orientations of the components, projection frusta and screen geometry.
System-space. The co-ordinate system in which the display hardware is defined.
View(ing) volume. The volume in which users may see imagery generated by a display system. (Typically clipped by a particular field-of-view and usable depth range.)
Virtual Projectors. The reflection of a projector in a side mirror (for example), with the partial frustum appearing to originate from the projector image.
World-space. The global co-ordinate system in which all 3D objects and corresponding object-spaces are defined.

1. A method comprising:
receiving image information in a form representative of a three dimensional (3D) object;
operating on the received image information to compensate for a projector bias associated with one or more projectors by transforming a projector perspective of the 3D object into a viewing region perspective; and
projecting light corresponding to the operated on image information from each of the one or more projectors through a screen to a viewing region.

2. The method according to claim 1 wherein the received image information is operated on by one or more virtual cameras positioned on the same side of the screen as the one or more projectors.

3. The method according to claim 1 wherein the projector bias comprises one or more of a positional, orientational or optical variation between the one or more projectors.

4. The method according to claim 1 further comprising reflecting the light from a mirror before projecting the light through the screen, to produce at least one virtual frustum.

5. The method according to claim 1 further comprising apportioning the viewing region into individual sub-regions, wherein imagery associated with each sub-region may be controlled independently of other sub-regions.

6. The method according to claim 1 wherein the image information is projected by different projectors according to an apparent distance from the screen of different parts of the 3D object.

7. The method according to claim 6 wherein parts of the 3D object relatively close to the screen are displayed using a perspective projector, and parts of the 3D object relatively distant from the screen are displayed using an orthographic projector.

8. The method according to claim 6 further comprising varying projection parameters of the object parts according to the apparent distance of the object parts from the screen.

9. A system comprising:
a screen;
a plurality of projectors configured to illuminate the screen with light, the light forming a three dimensional (3D) object for display in a viewing region; and
one or more processors configured to generate image information associated with the 3D object, the image information calibrated to compensate for a projector bias of the plurality of projectors by transforming a projector perspective of the 3D object to a viewing region perspective.

10. The system according to claim 9 further comprising one or more virtual cameras positioned on the same side of the screen as the plurality of projectors, the one or more virtual cameras configured to operate on the image information.

11. The system according to claim 9 wherein the projector bias comprises one or more of a positional, orientational or optical variation between the plurality of projectors.

12. The system according to claim 9 further comprising a mirror configured to reflect the light towards the screen to increase a view volume size of the viewing region.

13. The system according to claim 12 wherein the one or more processors generate two rendered images that are aligned on either side of a mirror boundary.

14. The system according to claim 9 wherein the screen is arranged to have a wide angle of dispersion in at least one axis.

15. The system according to claim 9 wherein the screen is arranged to have a narrow angle of dispersion in at least one axis.

16. The system according to claim 9 wherein the screen is curved.

17. The system according to claim 9 wherein the one or more processors are configured to compensate for the projector bias associated with each of the plurality of projectors.

18. The system according to claim 17 further comprising one or more video cameras configured to provide the image information that is operated on by the one or more processors.

19. A computer-readable medium having instructions stored thereon, wherein when the instructions are executed by at least one device, they are operable to:
receive image information to be displayed, in a form representative of a 3D object;
distribute at least part of the image information to each projector in an array of projectors;
render different parts of the image information to project a distributed image within each projector's frustum;
operate on the image information prior to rendering the different parts to compensate for a projector bias;
illuminate the screen from a different angle corresponding to each projector; and
combine the distributed images into a predetermined view of an autostereo image in a view volume.

20. The computer readable medium according to claim 19 wherein the distributed images are rendered using a virtual image generation camera co-located with each projector.

21. The computer readable medium according to claim 19 wherein a virtual image generation viewpoint for rendering the distributed images is co-located at or near each projector.

22. The computer readable medium according to claim 19 wherein the screen is configured to allow light from each projector to pass through the screen to form the autostereo image in the view volume.

23. The computer readable medium according to claim 19 wherein operating on the image information creates a virtual frustum that is offset from and coplanar to the projector's frustum, the distributed image appearing to originate within the virtual frustum.

24. A system comprising:
a means for scattering light;
means for projecting light on the means for scattering light, the light forming a three dimensional (3D) object for display in a viewing region; and
means for generating image information associated with the 3D object, the image information calibrated to compensate for a distortion of the means for projecting light by transforming a display perspective of the 3D object to a viewing region perspective.

25. The system according to claim 24 farther comprising one or more virtual cameras positioned on the same side of the means for scattering light as the means for projecting light, the one or more virtual cameras configured to operate on the image information.

26. The system according to claim 24 wherein the distortion comprises one or more of a positional, orientational or optical variation of the means for projecting light.

27. The system according to claim 24 farther comprising a means for reflecting the light towards the means for scattering light to increase a view volume size of the viewing region.

28. The system according to claim 27 wherein the means for generating image information generates two rendered images that are aligned on either side of a boundary of the means for reflecting light.

29. The system according to claim 24 wherein the means for projecting light comprises separate projectors and the means for generating image information comprises separate processors configured to compensate for the distortion associated with each of the separate projectors.

30. The system according to claim 29 further comprising one or more means for recording the image information that is operated on by the means for projecting light.
